(19) United States
(12) Patent Application Publication
(10) Pub. No.: US 2007/0041049 A1
(43) Pub. Date: Feb. 22, 2007

(54) Image forming system

(75) Inventors: Takeo Kojima, Kanagawa (JP); Takashi Inui, Kanagawa (JP); Amiko Shimizubata, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/395,258

(22) Filed: Apr. 3, 2006

(30) Foreign Application Priority Data
Aug. 16, 2005 (JP) 2005-235784
Aug. 18, 2005 (JP) 2005-237236

(51) Int. Cl. G06K 15/00

(52) U.S. Cl. 358/1.16

(57) ABSTRACT

An image forming system includes: a first image forming device forming an image on continuous paper fed from a first feeding device; and a turn bar device provided on downstream of the first image forming device and wrapping the continuous paper around a turn bar arranged at approximately 45°, with respect to an advancing direction, reversing front and rear surfaces thereof. The turn bar device includes a first transport path carrying the continuous paper out approximately perpendicular to the carrying-in direction, a second transport path for transporting the continuous paper out in the same direction as the first transport path carrying-in direction. The image forming system further includes a second image forming device that forms an image on continuous paper carried out of the first transport.

### CROSS-REFERENCE TO RELATED APPLICATIONS

This application claims priority under 35 USC 119 from Japanese Patent Applications Nos. 2005-235784 and 2005-237236, the disclosures of which are incorporated by reference herein.

### BACKGROUND

1. Field of the Invention

The present invention relates to an image forming system that has plural image forming devices for forming images on continuous paper.

2. Description of the Related Art

Conventionally, duplex continuous printing systems in which plural printer devices are configured together and printing is performed on continuous paper are known.

As shown in FIG. 19, a duplex continuous printing system 900 is constituted so that printer devices 902 and 903, which form images on continuous paper 910 according to an electrophotographic method, are arranged orthogonally into an L shape. A buffer device 904, an auxiliary transport device 906, and a turn bar device 908 are arranged on a downstream side of the printer device 902. The turn bar device 908 winds the continuous paper 910 around a turn bar 909, which is arranged at approximately 45° with respect to an advancing direction of the continuous paper, so as to reverse the front and rear surfaces of the continuous paper, and convey the paper out in a direction approximately perpendicular to the carrying-in direction.

The duplex continuous printing system 900 that utilizes such a turn bar device 908 prints images on both the surfaces of the continuous paper 910 in the following manner. After the printer device 902 on an upstream side prints an image on a front surface of the continuous paper 910, the turn bar device 908 turns the continuous paper 910 so that a rear surface, on which an image should be printed, is face upward, and changes the transport direction into a right angle and conveys it into the printer device 903 on the downstream side so as to print the image on the rear surface of the continuous paper 910.

A paper feeding device 912 is provided at the end on the upstream side of the duplex continuous-printing system 900, so that tens of thousand to hundreds of thousand sheets of paper can be processed at one time with a single refill of paper, and a post-processing device 914 that cuts the continuous paper 910 so as to stack them is provided to the end on the downstream side.

Cases where the two printer devices 902 or 903 individually print images only on one surface of the continuous paper 910 in such an duplex continuous-printing device 900 will be considered.

In a case where printing is performed by using only the printer device 902 on the upstream side, it is necessary to move the turn bar device 908 and the post-processing device 914 so as to change the arrangement as shown in FIG. 20.

Similarly in a case where printing is performed by using only the printer device 903 on the downstream side, it is necessary to move the turn bar 908 and the paper feeding device 912 so as to change the arrangement as shown in FIG. 21.

Since the paper feeding device 912 and the post-processing device 914, however, weigh several hundred kg or more, it is very difficult to change the arrangement. Further, according to such a change in the arrangement, it is necessary to replace and reconnect cables between the devices.

In order to print an image only on one surface without changing the arrangement, the printer device 903 on the downstream side (or the printer device 902 on the upstream side) is operated in the state of FIG. 19 so that the rear surface (or front surface) of the continuous paper is blank (no print data). In this method, however, since the printer device 903, which does not actually perform printing, operates, there arises a problem such that a photoreceptor (not shown) is worn out although printing is not actually performed.

### SUMMARY

The present invention is in view of the above circumstances and provides an image forming system.

A first aspect of the invention provides an image forming system including a plurality of image forming devices, and having a simplex mode that an image is formed on a front surface of a continuous medium, and a duplex mode that an image is also formed on a rear surface of a continuous medium, the system including: a first feed device that feeds a continuous medium; a first image forming device that forms an image on the continuous medium fed from the first feeding device; a turn bar device that is provided on a downstream side of the first image forming device; the turn bar device comprising a first transport path that the continuous medium is transported in from the first image forming device, and transported out in a direction substantially perpendicular to the transporting-in direction of the continuous medium in a state that the continuous medium is wrapped around a turn bar arranged at approximately 45° with respect to the advancing direction of the continuous medium to reverse the front and rear surfaces of the continuous medium, and a second transport path that the continuous medium out in a direction that is substantially the same as the transporting-in direction of the first transport path; a first post-processing device that post-processes the continuous medium transported out by the second transport path of the turn bar device; a second image forming device that forms an image on the continuous medium transported out by the first transport path of the turn bar device; and a second post-processing device that is provided on a downstream side of the second image forming device and post-processes the continuous medium; in the simplex mode, the continuous medium fed from the first feeding device being transported to the first post-processing device via the first image forming device and second transport path, and in the duplex mode, the continuous medium being transported to the second post-processing device via the first image forming device, first transport path, and second image forming device.

A second aspect of the invention provides an image forming system including a plurality of image forming devices, and having a simplex mode that an image is formed on a front surface of a continuous medium, and a duplex mode that an image is also formed on a rear surface of a continuous medium, the system including: a first feed device that feeds a first feed of continuous medium; a first image forming device that forms an image on the continuous medium fed from the first feeding device; a turn bar device that is provided on a downstream side of the first image forming device; the turn bar device comprising a first transport path that the first feed of continuous medium is transported in from the first image forming device, out in a direction substantially perpendicular to the transporting-in direction of the first feed of continuous medium in a state that the first feed of continuous medium is wound around a turn bar arranged at approximately 45° with respect to the advancing direction of the first feed of continuous medium to reverse the front and rear surfaces of the first feed of continuous medium, and a second transport path that transports in and out a second feed of continuous medium in a direction that is the same as the transporting-out direction of the first transport path; a second feeding device that feeds the second feed of continuous medium to the second transport path of the turn bar device; a second image forming device that forms an image on the first or second feed of continuous medium transported out from the turn bar device; and a second post-processing device that is provided on a downstream side of the second image forming device and post-processes the first or second feed of continuous medium.

A third aspect of the invention provides an image forming system including a plurality of image forming devices, and having a simplex mode that an image is formed on a front surface of a continuous medium, and a duplex mode that an image is also formed on a rear surface of a continuous medium, the system including: a first feed device that feeds a first feed of continuous medium; a first image forming device that forms an image on the first feed of continuous medium fed from the first feeding device; a turn bar device that is provided on a downstream side of the first image forming device; the turn bar device comprising a first transport path that the continuous medium is transported in from the first image forming device, and transported out in a direction substantially perpendicular to the transporting-in direction of the first feed of continuous medium in a state that the first feed of continuous medium is wound around a turn bar arranged at approximately 45° with respect to the advancing direction of the first feed of continuous medium to reverse the front and rear surface of the first feed of continuous medium, a second transport path for transporting out a first feed of continuous medium in a direction that is substantially the same as the transporting-in direction of the first transport path, and a third transport path that transports in and out a second feed of continuous medium in a direction that is substantially the same as the transporting-out direction of the first transport path; a first post-processing device that post-processes the first feed of continuous medium transported out of the second transport path of the turn bar device; a second image forming device that forms an image on the first or second feed of continuous medium transported out of the first transport path of the turn bar device; and a second post-processing device that is provided on a downstream side of the second image forming device and post-processes the first or second feed of continuous medium; in the simplex mode, the first feed of continuous medium fed from the first feeding device being transported to the first post-processing device via the first image forming device and second transport path, and in the duplex mode, the first feed of continuous medium being transported to the second post-processing device via the first image forming device, first transport path, and second image forming device.

### BRIEF DESCRIPTION OF THE DRAWINGS

Embodiments of the present invention will be described in detail based on the following figures, in which:

FIG. 1 is a diagram illustrating an duplex continuous printing system according to a first embodiment of the invention;

FIG. 2 is a diagram illustrating an internal constitution of a first image forming device and a second image forming device;

FIG. 3 is a perspective view illustrating a turn bar device of the duplex continuous printing system according to the first embodiment;

FIG. 4A is a diagram illustrating a case where detection is made as to whether continuous paper is wrapped on a turn bar or not by means of a sensor and a reflection plate, and the continuous paper is not wrapped on the turn bar;

FIG. 4B is a diagram illustrating a case where detection is made as to whether continuous paper is wrapped on the turn bar by means of the sensor and the reflection plate, and the continuous paper is wrapped on the turn bar;

FIG. 5 is a diagram illustrating the duplex continuous printing system of the first embodiment where printing is performed in a duplex continuous mode;

FIG. 6 is a diagram illustrating a turn bar device of the duplex continuous printing system according to the first embodiment where the continuous paper is transported in the duplex mode;

FIG. 7 is a diagram illustrating the duplex continuous printing system of the first embodiment where printing is performed in simplex modes;

FIG. 8 is a diagram illustrating the turn bar device of the duplex continuous printing system according to the first embodiment where the continuous paper is transported in the simplex modes;

FIG. 9 is a diagram illustrating a schematic constitution of a control device of the duplex continuous printing system according to the first embodiment;

FIG. 10 is a chart diagram explaining operation of the duplex continuous printing system in the simplex mode according to the first embodiment;

FIG. 11 is a chart diagram illustrating an operation of the duplex continuous printing system in the duplex mode according to the first embodiment;

FIG. 12 is a diagram illustrating another example of the turn bar device;

FIG. 13 is a diagram illustrating the duplex continuous printing system according to a second embodiment of the invention where printing is performed in the duplex mode;

FIG. 14 is a diagram illustrating the duplex continuous printing system according to the second embodiment where printing is performed in the simplex mode;

FIG. 15 is a diagram illustrating the turn bar device of the duplex continuous printing system according to the second embodiment where the continuous paper is transported in the simplex mode;

FIG. 16 is a diagram illustrating the duplex continuous printing system according to a third embodiment of the invention where printing is performed in the duplex mode;

FIG. 17 is a diagram illustrating the duplex continuous printing system according to the third embodiment where printing is performed in the simplex mode;

FIG. 18 is a diagram illustrating the turn bar device of the duplex continuous printing system according to the third embodiment where the continuous paper is transported in the simplex mode;

FIG. 19 is a diagram illustrating a conventional duplex continuous printing system;

FIG. 20 is a diagram explaining an arrangement conversion of the respective devices in the case, where printing is performed on one surface of the continuous paper using only the image forming device on an upstream side, in the conventional duplex continuous printing system;

FIG. 21 is a diagram explaining an arrangement conversion of the respective devices in the case, where printing is performed on one surface of the continuous paper using only the image forming device on a downstream side, in the conventional duplex continuous printing system;

FIG. 22 is a diagram typically illustrating a buffer device;

FIG. 23 is a table illustrating relationships between a transport path selection signal, a transport path signal and a transport path error signal;

FIG. 24 is a table illustrating relationships between a buffer-full signal and a temporary stop signal 1;

FIG. 25 is a table illustrating relationships between a transport path selection signal, a buffer-empty signal and a temporary stop signal 2;

FIG. 26 is a table illustrating relationships between a transport path selection signal, a jam signal, an error signal 1 and a stop signal 1;

FIG. 27 is a table illustrating relationships between a transport path selection signal, a jam signal, an error signal 1 and a stop signal 1.

### DETAILED DESCRIPTION

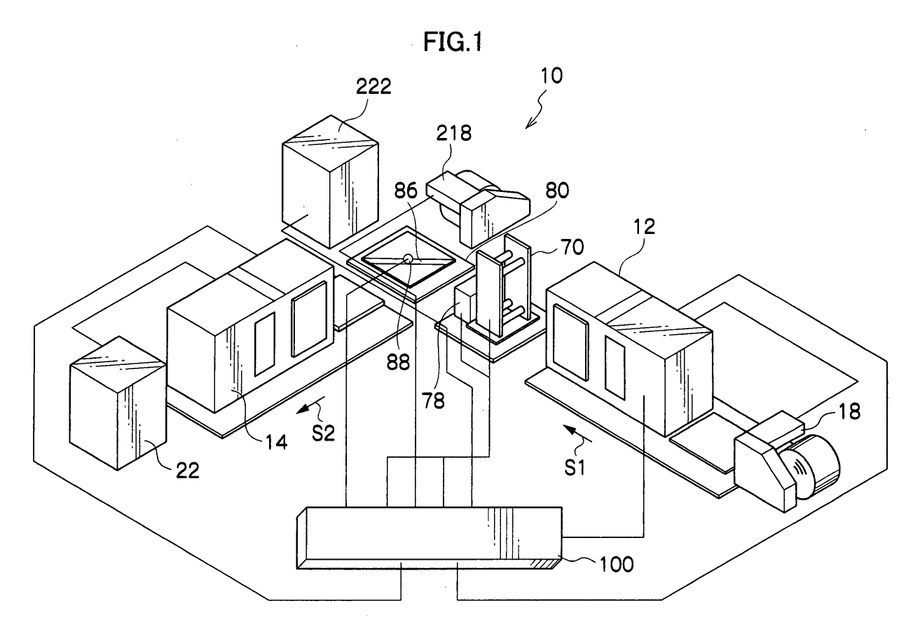

FIG. 1 illustrates a constitution of an duplex continuous printing system 10 according to a first embodiment of the present invention. The duplex continuous printing system 10 is constituted so that a first image forming device 12 on an upstream side and a second image forming device 14 on a downstream side that form an image on continuous paper 28 are arranged into an L shape orthogonally.

Schematic constitutions of the first image forming device 12 and the second image forming device 14, and an image forming process are explained. Since the first image forming device 12 and the second image forming device 14 have the same constitution, they are explained without discriminating them.

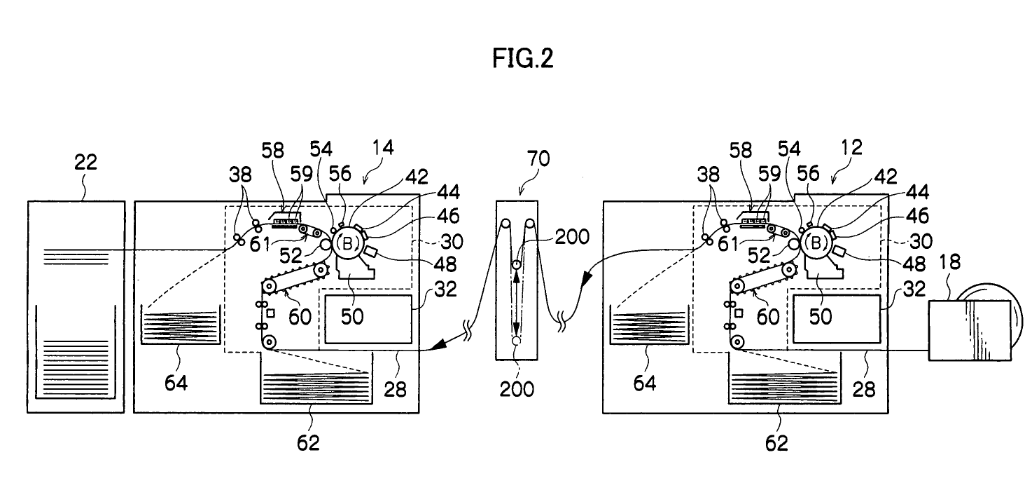

As shown in FIG. 2, the first image forming device 12 and the second image forming device 14 have an image forming unit 30 that forms an image on the continuous paper 28. They have a control unit 32 that controls the devices overall.

In the image forming unit 30, after a photoreceptor 42 that rotates to a direction B is charged uniformly by charging devices 44 and 46, it is exposed by an LED unit 48. As a result, an electrostatic latent image according to an image is formed on the photoreceptor 42. The electrostatic latent image formed on the photoreceptor 42 is developed by a developing machine 50 so as to be a toner image.

The continuous paper 28 is transported to a transfer device 52 by a transport mechanism 60, and the toner image on the photoreceptor 42 is transferred to a front surface 28A of the continuous paper 28 by the transfer device 52.

The continuous paper 28 onto which the toner image is transferred is transported to a fixing device 58 by a transport mechanism 61, and the toner image is fixed to the continuous paper 28. The continuous paper 28 to which the toner image is fixed is discharged out of the first image forming device 12 and the second image forming device 14 by discharge rollers 38.

After the toner image is transferred to the continuous paper 28, toner on the photoreceptor 42, which remains not transferred onto the continuous paper 28 by the transfer device 52, is removed by a cleaning device 54. The entire surface of the photoreceptor 42 is discharged by a discharge LED device 56, and the photoreceptor 42 is again charged by the charging devices 44 and 46, so that an electric potential of the photoreceptor 42 becomes uniform.

The first image forming device 12 and the second image forming device 14 contains a housing unit 62 that houses the continuous paper in a folded state, and they contain a housing unit 64 that houses the continuous paper formed with an image in a folded state. The first image forming device 12 and the second image forming apparatus 14 can form an image as a single device, respectively. The single device, however, can print an image only on a few thousands of sheets of paper at most.

The duplex continuous printing system 10, therefore, has a first continuous paper feeding device 18 that can mount several tens of thousand to hundreds of thousand sheets of the continuous paper 28 on the upstream side of the first image forming device 12 so that several tens of thousand to hundreds of thousand sheets of the continuous paper 28 can be processed at a time. The continuous paper 28 is mounted to the first continuous paper feeding device 18, and it feeds the mounted continuous paper 28 to the first image forming device 12. A second post-processing device 22 that cuts and stacks the continuous paper 28 is disposed on the downstream side of the downstream second image forming device 14.

As shown in FIG. 1, a buffer device 70 is disposed on the downstream side of the first image forming device 12, and an auxiliary transport unit 78 is disposed on the downstream side of the buffer device 70. A turn bar device 80 is provided to the downstream side of the auxiliary transport unit. The turn bar device 80 is disposed at a corner of the L-shape formed by the first image forming device 12 and the second image forming device 14. The turn bar device 80 is detailed later.

An advancing direction of the continuous paper in the first image forming device 12 is represented by an arrow S1, and an advancing direction of the continuous paper in the second image forming device 14 is represented by an arrow S2. Both the directions are perpendicular to each other at the turn bar device 80.

A first post-processing device 222 is disposed on the downstream side of the turn bar device 80 with respect to the feeding direction S1 of the continuous paper 28 in the first image forming device 12. A second continuous paper feeding device 218 is disposed on the upstream side of the turn bar device 80 with respect to the feeding direction S2 of the continuous paper 28 in the second image forming device 14. The second continuous paper feeding device 218 and the first post-processing device 222 have similar constitutions to those of the first continuous paper feeding device 18 and the second post-processing device 22.

In the duplex continuous printing system 10, all the devices are arranged into an “X” shape.

The turn bar device 80 is explained below.

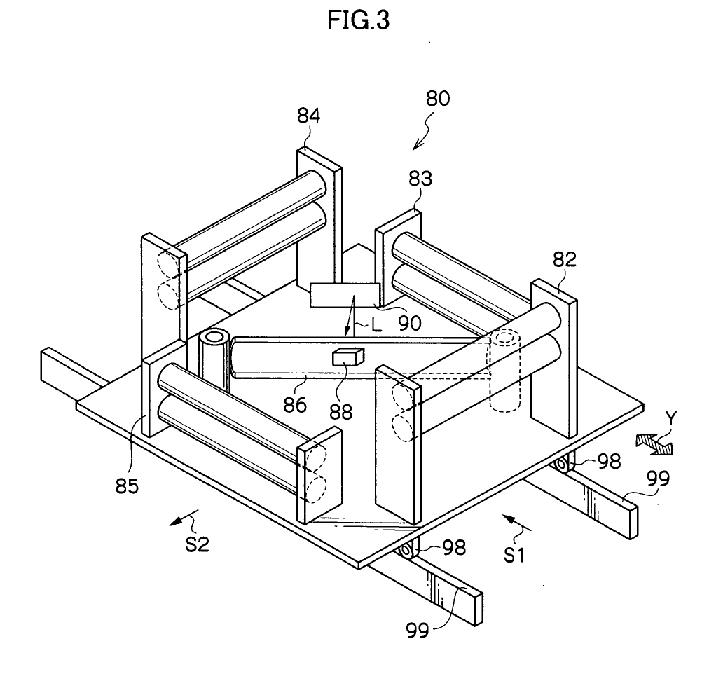

As shown in FIG. 3, the turn bar device 80 has an approximately square shape when viewed from top. Respective sides of the approximately square shape have paper transport units 82, 83, 84 and 85 that are composed of a pair of rollers and hold to transport the continuous paper 28.

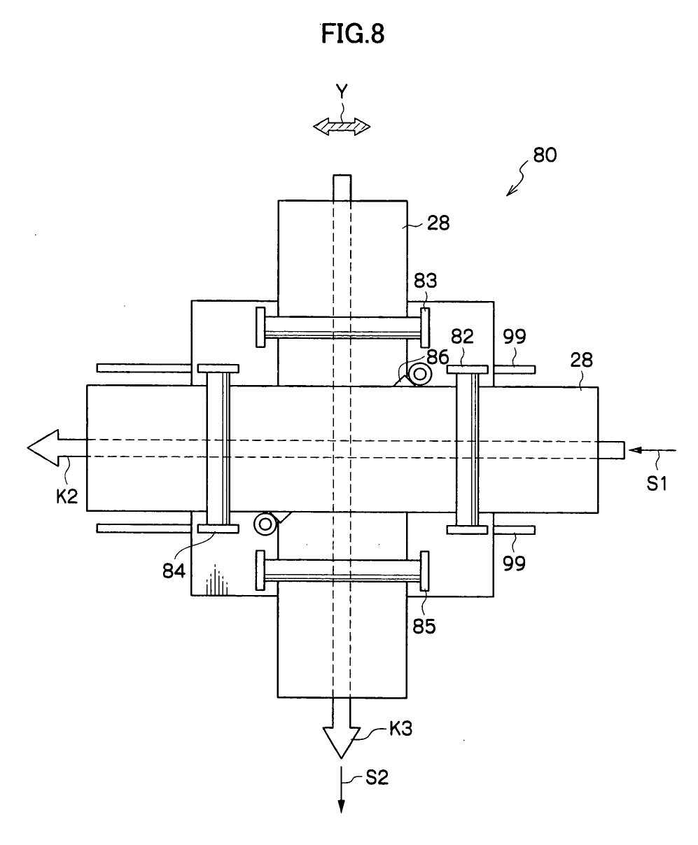

The paper transport units 82 and 84 are at the same height, and as shown in FIG. 8, transport the continuous paper 28 in the same direction as the advancing direction S1 of the continuous paper 28 in the first image forming device 12. A transport path where the continuous paper 28 fed from the first image forming device 12 is carried in from the paper transport unit 82 and carried out of the paper transport unit 84 is a second transport path K2.

The paper transport units 83 and 85 are at the same height, and transport the continuous paper 28 fed from the second continuous paper feeding device 218 in the same direction as the advancing direction S2 of the continuous paper 28 in the second image forming device 14. A transport path where the continuous paper 28 fed from the second continuous paper feeding device 218 is carried in from the paper transport unit 83 and carried out of the paper transport unit 85 is a third transport path K3.

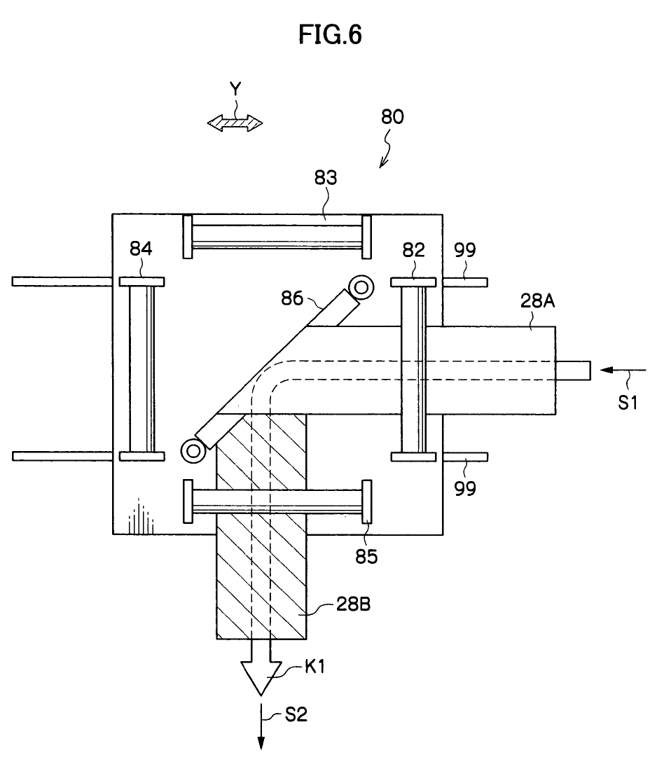

As shown in FIGS. 3, 6 and 8, the turn bar device 80 is provided with a turn bar 86 which is arranged at an approximately 45° with respect to the advancing direction S1 of the continuous paper 28 fed from the first image forming device 12. As shown in FIG. 6, the continuous paper 28 carried in from the paper transport unit 82 is wound around the turn bar 86 so that the faces thereof are reversed, and their advancing direction is converted into a perpendicular direction, namely, the advancing direction S2 of the continuous paper 28 in the second image forming device 14 so that the continuous paper 28 is carried out of the paper transport unit 85. A transport path where, after the continuous paper 28 fed from the first image forming device 12 is carried in from the paper transport unit 82, its advancing direction is converted at 90°, and the continuous paper 28 is carried out of the paper transport unit 85, is a first transport path K1.

As shown in FIG. 3, the paper transport units 82 and 84 are in the higher position than that of the paper transport units 83 and 85, and the turn bar 86 is at a height between that of the paper transport units 82 and 84 and the paper transport units 83 and 85.

As shown in FIG. 8, therefore, since heights of the second transport path K2 and the third transport path K3 are different, namely, they are disposed in up and down positions, the continuous paper 28 can be transported along both transport paths in a cross state.

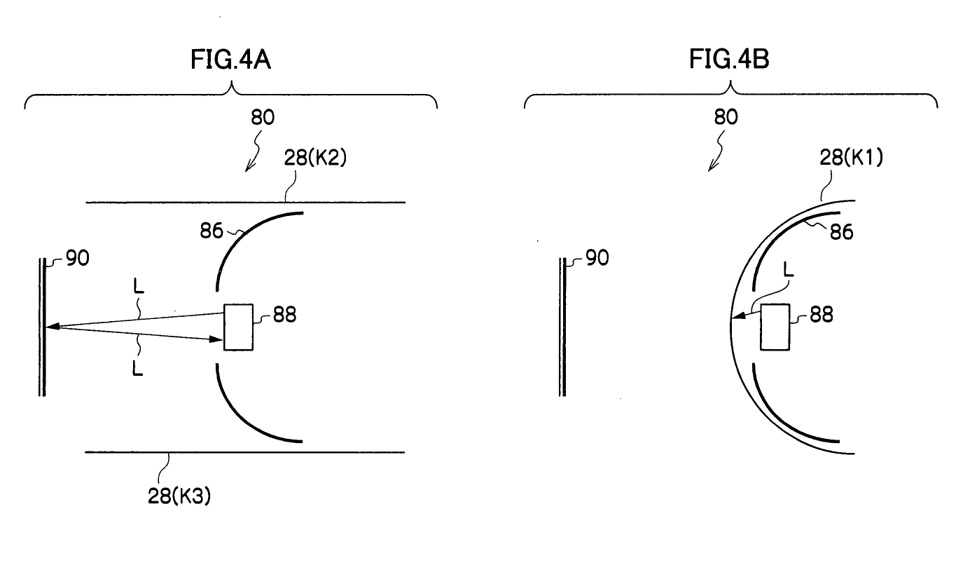

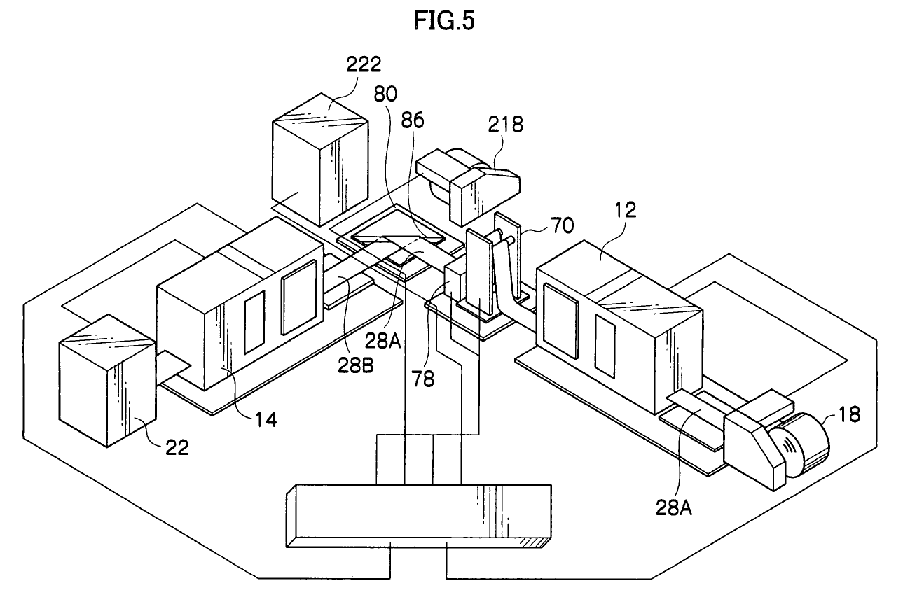

As shown in FIG. 3, the turn bar 86 is provided with a sensor 88. Also as shown in FIG. 4A, the sensor 88 emits sensor light L from a face of the turn bar 86 around which the continuous paper 28 is wound. A reflection plate 90 is provided in a position opposed to the sensor 88.

As shown in FIG. 4A, therefore, in the case where the continuous paper 28 is not wound around the turn bar 86 (the continuous paper 28 is transported through the second transport path K2 and the third transport path K3), the sensor light L emitted from the sensor 88 is reflected by the reflection plate 90 and is received by a light receiving unit (not shown) of the sensor 88. As shown in FIG. 4B, in the case where the continuous paper 28 is wound around the turn bar 86 (the continuous paper 28 is transported through the first transport path K1), since the sensor light L is blocked by the continuous paper 28 and is not reflected by the reflection plate 90, the light receiving unit of the sensor 88 does not receive the sensor light L. That is to say, it is known whether the continuous paper 28 is wound around the turn bar 86 or not by using the sensor 88 and the reflection plate 90. A detection signal from the sensor 88 becomes Low when the sensor light L reflected by the reflection plate 90 is received, and becomes High when the sensor light L reflected by the reflection plate 90 is not received. In other words, the case in FIG. 4A shows Low and the case in FIG. 4B shows High.

The duplex continuous printing system 10 having such a constitution has two image forming modes: a simplex mode, for forming an image on the front surface 28A of the continuous paper 28 using respectively the first image forming device 12 or the second image forming device 14; and a duplex mode for forming an image on both the front surface 28A and the rear surface 28B of the continuous paper 28 using both the first image forming device 12 and the second image forming device 14.

The duplex mode will be explained first.

As shown in FIG. 5, the continuous paper 28 is fed from the first continuous paper feeding device 18 to the first image forming device 12, and an image is formed on the front surface 28A of the continuous paper 28. The continuous paper 28 whose front surface 28A is formed with the image is fed to the buffer device 70 so that a further transport force is applied thereto by the auxiliary transport unit 78, and the continuous paper 28 is carried into the turn bar device 80. As shown in FIG. 6, the continuous paper 28 passes through the first transport path K1 of the turn bar device 80. That is to say, after the continuous paper 28 is carried in from the paper transport unit 82, its faces are reversed by the turn bar 86 and the advancing direction S1 is changed into the advancing direction S2, so that the continuous paper 28 is carried out from the paper transport unit 85.

As shown in FIG. 5, the second image forming device 14 forms an image on the rear surface 28B of the carried-out continuous paper 28.

After the image is formed on both the surfaces of the continuous paper 28, the continuous paper 28 is finally fed to the second post-processing device 28, and is cut and stacked.

As shown in FIG. 2, even if a center roll 200 in the three rolls of the buffer device 70 moves up and down, as shown by a dotted lines, so that transport speeds of the first image forming device 12 and the second image forming device 14 are slightly different from each other, the buffer device 70 prevents malfunctions such as where the continuous paper 28 is pulled and breaks, or the continuous paper 28 slackens and is creased.

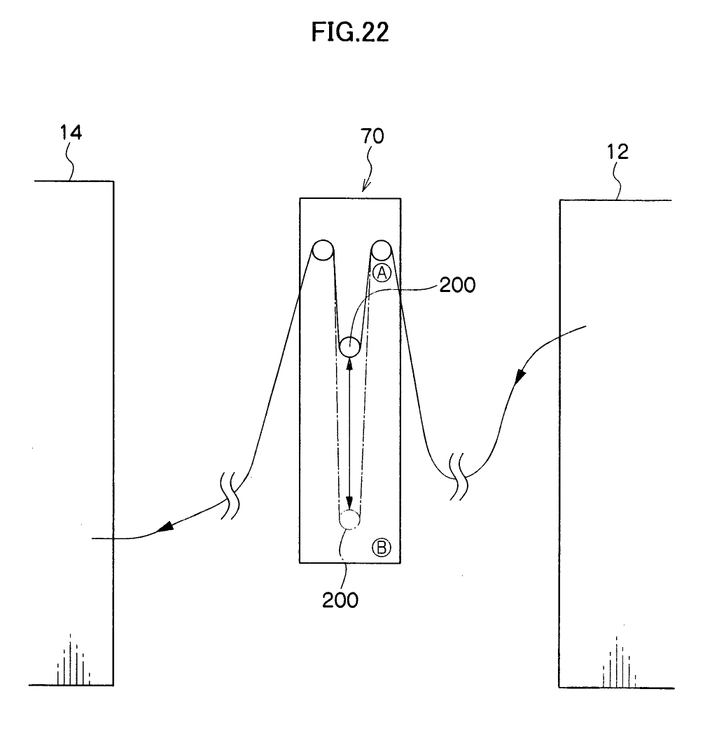

As shown in FIG. 22, when the center roll 200 gets higher than a predetermined position, the buffer device 70 outputs a buffer-empty signal. When the center roll 200 gets lower than a predetermined position, the buffer device 70 outputs a buffer-full signal.

When the buffer-empty signal is output, a control device 100 (details are mentioned later) shuts off the operation of the second image forming device 14 on the downstream side and lowers the center roll 200. When the buffer-full signal is output, the control device 100 shuts off the operation of the first image forming device 12 on the upstream side, and raises the center roll 200.

When a jam occurs in the buffer device 70, a jam signal is output. The signal is High at the time of occurrence of a jam. As a method of detecting a jam, for example, a sensor that detects the continuous paper is provided at a position A where the continuous paper should be present and a position B where the continuous paper should not be present in the drawing, and when the position A is detected but the position B is not detected, the state is normal, but in other cases, the state is not normal so that occurrence of jam is detected.

In the duplex mode, a signal output by the sensor 88 of the turn bar device 80 (see FIG. 1) is Low.

As shown in FIG. 3, four wheels 98 are provided to four corners at the lower surface of the turn bar device 80 (only two are shown in FIG. 3). The wheels 98 are on rails 99 along the advancing direction S1, and the entire turn bar device 80 moves along the rails 99. A position of carrying-out into the second image forming device 14 can be, therefore, adjusted according to a width of the continuous paper 28.

The simplex mode is explained below.

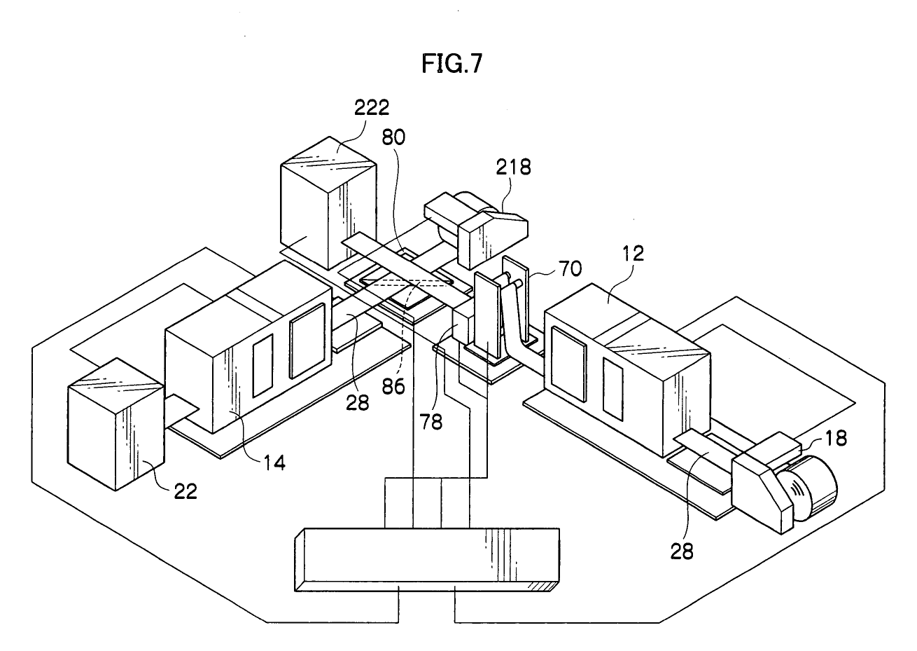

As shown in FIG. 7, the continuous paper 28 is fed from the first continuous paper feeding device 18 to the first image forming device 12 so that an image is formed on the continuous paper 28. The continuous paper 28 on which the image is formed is carried into the turn bar device 80 via the buffer device 70 and the auxiliary transport unit 78. As shown in FIG. 8, the continuous paper 28 on which the image is formed by the first image forming device 12 passes through the second transport path K2 of the turn bar device 80 so as to be carried out therefrom. The carried-out continuous paper 28 is fed to the first post-processing device 222 so as to be cut and stacked.

On the other hand, as shown in FIG. 7, the continuous paper 28 fed from the second continuous paper feeding device 218 is carried into the turn bar device 80. As shown in FIG. 8, the continuous paper 28 passes through the third transport path K3 of the turn bar device 80 so as to be carried out therefrom.

As shown in FIG. 7, after an image is formed on the carried-out continuous paper 28 by the second image forming device 14, the continuous paper 28 is fed to the second post-processing device 22 so as to be cut and stacked.

In the case of the simplex mode, even if the transport speeds of the first image forming device 12 and the second image forming device 14 are slightly different from each other, the continuous paper 28 does not get pulled and break nor slacken and crease. For this reason, the buffer device 70 requires only a function for transporting the continuous paper 28 on the upstream side, and thus does not require adjustment to the up-down movement of the center roll 200 (it is not related thereto).

In the case of the simplex mode, the signal output from the sensor 88 of the turn bar device 80 is Low.

Next, the connection of cables for transmitting/receiving interface signals among the devices will be explained.

As shown in FIG. 1, the first continuous paper feeding device 18 is connected to the first image forming device 12 (control unit 32), and the first image forming device 12 is connected to the control device 100 (details are mentioned later). Similarly, the second post-processing device 22 is connected to the second image forming device 14 (control unit 32), and the second image forming device 14 is connected to the control device 100.

The buffer device 70, the auxiliary transport unit 78, the second continuous paper feeding device 218 and the first post-processing device 222 are, respectively, connected to the control device 100.

The detection signal from the sensor 88 of the turn bar device 80 is also sent to the control device 100. Since this detection signal represents whether the continuous paper 28 is transported in duplex mode or simplex mode, this detection signal is sometimes referred to below as a transport path signal.

The first image forming device 12 outputs a signal representing whether printing in duplex mode or the printing in simplex mode is selected, namely, a transport path selection signal as the printing mode signal to the control device 100. When the first image forming device 12 and the second image forming device 14 are operated, they output transport signals 1I and 2I, respectively.

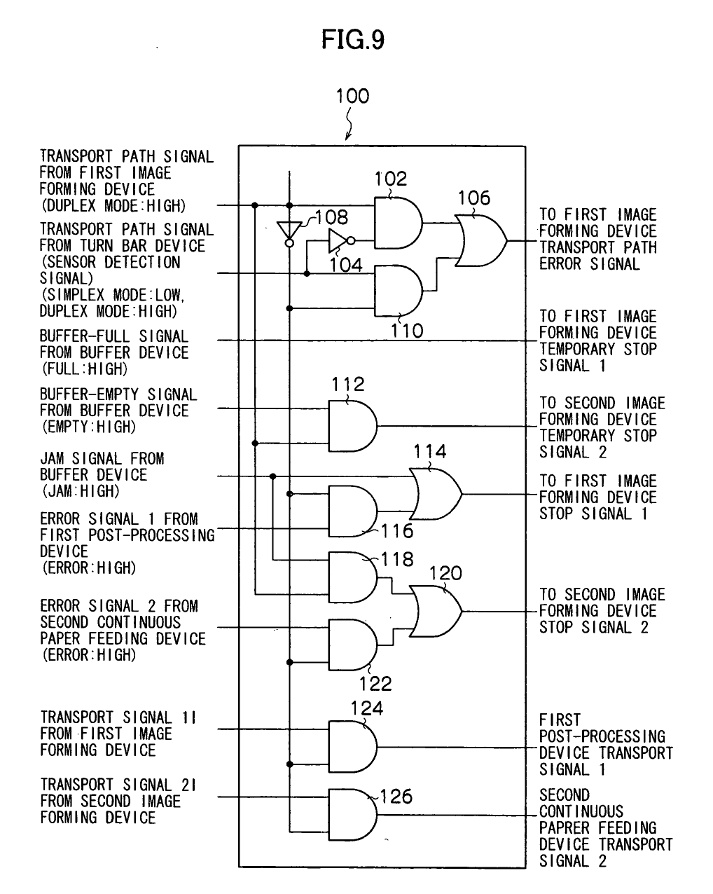

The control device 100 is explained with reference to FIG. 9. FIG. 9 is a diagram illustrating a schematic constitution, and does not illustrate a power supply circuit and a driver circuit.

The control device 100 aggregates the transport path signal, output from the turn bar device 80 (detection signal from the sensor 88 of the turn bar device 80), and interface signals from the respective devices, and controls the operations of the first image forming device 12 and the second image forming device 14 based on the transport path selection signal output from the first image forming device 12.

As shown in FIG. 9, the transport path selection signal output from the first image forming device 12 (High in the case of the duplex mode, and Low in the case of the simplex mode) is input into an AND circuit 102. The transport path signal output from the turn bar device 80 (detection signal from the sensor 88 of the turn bar device 80, Low in the case of the simplex mode, and High in the case of the duplex mode) is converted into a signal whose High signal and Low signal are reversed (namely, High in the simplex mode and Low in the duplex mode) by an inverter circuit 104, and the converted signal is also input into the AND circuit 102. When both the signals are High, the AND circuit 102 outputs the signals to an OR circuit 106.

The transport path selection signal output from the first image forming device 12 (High in the case of the duplex mode) is converted into a signal whose High signal is converted into a Low signal (namely, High in the simplex mode) by an inverter circuit 108, and the converted signal is input into an AND circuit 110. Transport path signal output from the turn bar device 80 (detection signal, High signal in the duplex mode) is also input into the AND circuit 110. When both the signals are High, the AND circuit 110 outputs a signal to the OR circuit 106.

When any one of the signals from the AND circuit 102 and the AND circuit 110 is input into the OR circuit 106, the OR circuit 106 outputs a transport path error signal to the first image forming device 12.

With such a circuit configuration, when the continuous paper 28 is mounted to the turn bar 80 properly, the OR circuit 106 does not transmit the transport error signal to the first image forming device 12, but when the continuous paper 28 is mounted to the turn bar device 80 improperly, the OR circuit 106 outputs the transport path error signal to the first image forming device 12.

The explanation is specifically given below. Hereinafter, High is occasionally abbreviated as H, and Low is occasionally abbreviated as L.

The case of the simplex mode will be explained.

When the continuous paper 28 is mounted to the turn bar device 80 properly, an L signal as the transport path selection signal and an H signal as the inverted transport path signal are input into the AND circuit 102. An H signal as the inverted transport path selection signal and an L signal as the transport path signal are input into the AND circuit 110. Since neither of the AND circuits 102 and 110, therefore, output a signal to the OR circuit 106, the OR circuit 106 does not output the transport error signal to the first image forming device 12. The first image forming device 12, therefore, can be operated.

When the continuous paper 28 is mounted to the turn bar device 80 improperly (in the case where the paper becomes mounted with the first transport path K1), an L signal as the transport path selection signal and an L signal as the inverted transport path signal are input into the AND circuit 102. An H signal as the inverted transport path selection signal and an H signal as the transport path signal are input into the AND circuit 110. The AND circuit 110, therefore, outputs a signal to the OR circuit 106, and the OR circuit 106 outputs the transport path error signal. The first image forming device 12, therefore, cannot be operated.

The case of the duplex printing is explained below.

When the continuous paper 28 is mounted to the turn bar device 80 properly, an H signal as the transport path selection signal and an L signal as the inverted transport path signal are input into the AND circuit 102. An L signal as the inverted transport path selection signal and an H signal as the transport path signal are input into the AND circuit 110. Since both the AND circuits 102 and 110, therefore, do not output a signal to the OR circuit 106, the OR circuit 106 does not output the transport path error signal. The first image forming device 12, therefore, can be operated.

When the continuous paper 28 is mounted to the turn bar device 80 improperly (in the case where the paper is mounted with the second transport path K2 and the third transport path K3), an H signal as the transport path selection signal and an H signal as the inverted transport path signal are input into the AND circuit 102. An L signal as the transport path selection signal and an L signal as the inverted transport path signal are input into the AND circuit 110. The AND circuit 102, therefore, outputs a signal to the OR circuit 106, and the OR circuit 106 outputs the transport path error signal to the first image forming device 12. The first image forming device 12, therefore, cannot be operated.

Only when the continuous paper 28 is mounted to the turn bar device 80 properly, is the first image forming device 12 able to operate.

In the above explanation, the transport path error signal is output to the first image forming device 12, but it may also be output to the second image forming device 14. Or the transport path error signal may be output to both the first image forming device 12 and the second image forming device 14.

The control device 100 is further explained.

When the center roll 200 of the buffer device 70 (see FIG. 2) is in a position lower than a predetermined position, a buffer-full signal is input, and a temporary stop signal is output to the first image forming device 12.

When the center roll 200 of the buffer device 70 (see FIG. 2)is in a position higher than another predetermined position, a buffer-empty signal is input into an AND circuit 112. The transport path selection signal output from the first image forming device 12 (high in the case of the duplex mode) is also input into the AND circuit 112. When both the signals are High (the duplex mode and the buffer-empty), the AND circuit 110 outputs a temporary stop signal to the second image forming device 14.

When a jam occurs in the buffer device 70, a jam signal is input into an OR circuit 114.

An error signal 1 output from the first post-processing device 222 is input into an AND circuit 116. An inverted transport path selection signal (H in the simplex mode), which is obtained by causing the transport path selection signal output from the first image forming device 12 (H in the duplex mode) to pass through the inverter circuit 108, is also input into the AND circuit 116. When both the signals are High (the simplex mode and an error occurs in the first post-processing device), the AND circuit 116 outputs a signal to the OR circuit 114.

When the OR circuit 114 is input with any one of the jam signal or the signal from the AND circuit 116, it outputs a stop signal 1 to the first image forming device 12.

The transport path selection signal output from the first image forming device 12 and the jam signal output from the buffer device 70 are input into an AND circuit 118, and when both the signals are High (the duplex mode and a jam occurs in the buffer device), the AND circuit 118 outputs a signal to an OR circuit 120.

An error signal 2 output from the second continuous paper feeding device 218 is input into an AND circuit 122. An inverted transport path selection signal, which is obtained by causing the transport path selection signal output from the first image forming device 12 to pass through the inverter circuit 108, is also input into the AND circuit 112. When both the signals are High, the AND circuit 122 outputs a signal to the OR circuit 120.

When the OR circuit 120 is input with any one of the signals from the AND circuits 118 and 120, it outputs a stop signal 2 to the second image forming device 14.

The transport signal 1I output from the first image forming device 12 is input into an AND circuit 124. A signal, which is obtained by causing the transport path selection signal output from the first image forming device 12 to pass through the inverter circuit 108, is also input into the AND circuit 124. When both the signals are High (the simplex mode and the first image forming device 12 operates), the AND circuit 124 transmits a transport signal 1 to the first post-processing device 222 so as to operate it.

The transport signal 2I output from the second image forming device 14 is input into an AND circuit 126. A signal, which is obtained by causing the transport path selection signal output from the first image forming device 12 to pass through the inverter circuit 108, is also input into the AND circuit 126. When both the signals are High, the AND circuit 126 transmits a transport signal 2 to the second continuous paper feeding device 218 so as to operate it.

The operations in the respective printing modes are explained in detail below.

An error signal 1 described below is a signal which is output when an error occurs in the first post-processing device 222. An error signal 2 is a signal which is output when an error occurs in the second continuous paper feeding device 218.

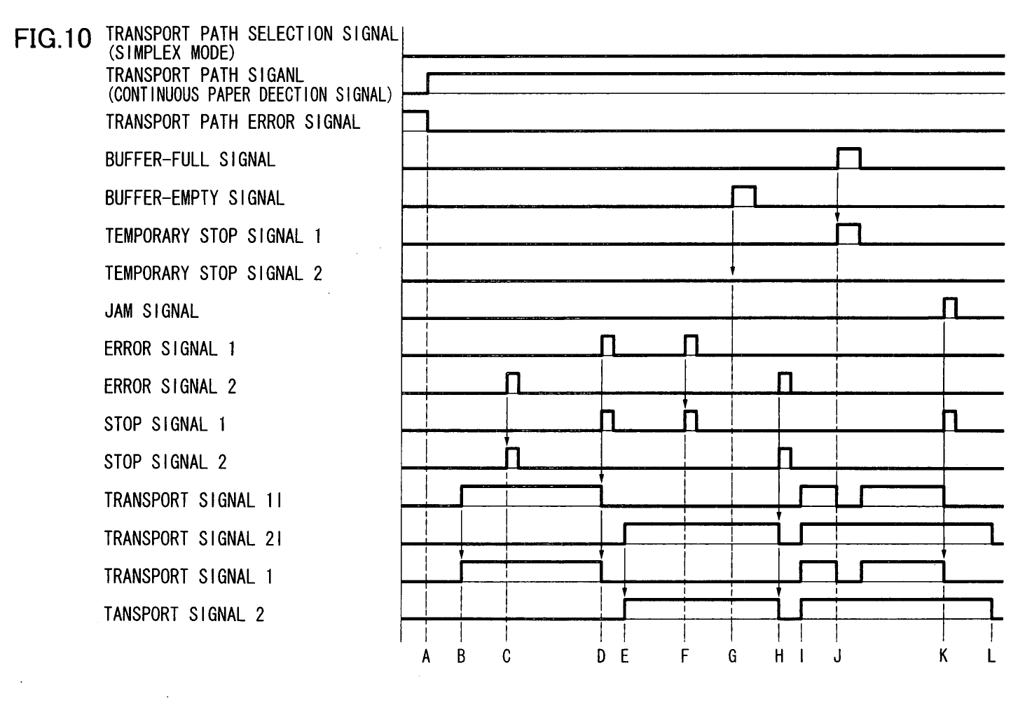

FIG. 10 is a chart illustrating the operation in the simplex modes (see FIGS. 7 and 8), and the operation in the simplex mode is explained below with reference to FIG. 10.

A: The transport path signal switches from H (duplex mode) into L (simplex mode), and the transport path error signal becomes Low (OFF), so that an image can be formed (as already described).

B: The first image forming device 12 starts printing. The transport signal 1I output from the first image forming device 12 is input into the AND circuit 124, and a signal which is obtained, by causing the transport path selection signal output from the first image forming device 12 (High in the duplex mode) to pass through the inverter circuit 108, namely, the signal which is obtained when an L signal in the simplex mode becomes an H signal is also input into the AND circuit 124. Since both the H signals are input into the AND circuit 124, the transport signal 1 to the first post-processing device 222 is output, so that the first post-processing device 222 is operated.

C: The error signal 2 output from the second continuous paper feeding device 218 is input into the AND circuit 122. A signal, which is obtained by causing the transport path selection signal output from the first image forming device 12 to pass through the inverter circuit 108, namely, the signal obtained when the L signal in the simplex mode becomes an H signal, is input into the AND circuit 122. The AND circuit 122, therefore, transmits a signal to the OR circuit 120, and the OR circuit 120 outputs a stop signal 2 to the second image forming device 14, but the first image forming device 12 continues printing.

D: The error signal 1 output from the first post-processing device 222 is input into other AND circuit 116. A signal which is obtained by causing the transport path selection signal output from the first image forming device 12 (High in the duplex mode) to pass through the inverter circuit 108, namely, a signal obtained when the L signal in the simplex mode becomes an H signal is input into the AND circuit 116. The AND circuit 116, therefore, outputs a signal to the OR circuit 114, and the OR circuit 114 outputs the stop signal 1 so that the first image forming device 12 is stopped.

E: The second image forming device 14 starts the printing. The transport signal 2I output from the second image forming device 14 is input into the AND circuit 126. A signal, which is obtained by causing the transport path selection signal from the first image forming device 12 to pass through the inverter circuit 108, namely, the signal obtained when the L signal in the simplex mode becomes an H signal is also input into the AND circuit 126. Since both the H signals are input into the AND circuit 126, the transport signal 2 is output to the second continuous paper feeding device 218, so that the second continuous paper feeding device 218 operates.

F: The error signal 1 output from the first post-processing device 222 is input into the AND circuit 116. A signal, which is obtained by causing the transport path selection signal output from the first image forming device 12 to pass through the inverter circuit 108, namely, the signal obtained when the L signal in the simplex mode becomes an H signal is input into the AND circuit 116. The AND circuit 116, therefore, outputs a signal to the OR circuit 114, and the OR circuit 114 outputs the stop signal 1, but the second image forming device 14 continues the printing.

G: A buffer-empty signal is input into the AND circuit 112. Since the transport path selection signal output from the first image forming device 12, namely, the L signal in the simplex mode, is input into the AND circuit 112, the temporary stop signal 2 is not output.

H: The error signal 2 output from the second continuous paper feeding device 218 is input into the AND circuit 122. A signal, which is obtained by causing the transport path selection signal output from the first image forming device 12 to pass through the inverter circuit 108, namely, the signal obtained when the L signal in the simplex mode becomes an H signal is also input into the AND circuit 122. The AND circuit 122, therefore, outputs a signal to the OR circuit 120, and the OR circuit 120 outputs the stop signal 2 to the second image forming device 14 so that the second image forming device 14 stops.

I: The first image forming device 12 and the second image forming device 14 start printing. The transport signals 1 and 2 are output. The transport signals 1 and 2 are output to the first post-processing device 222 and the second continuous paper feeding device 218, respectively.

J: The buffer-full signal becomes input, the temporary stop signal 1 is output, and therefore the fist image forming device 12 is temporarily stopped.

K: A jam signal is input into the OR circuit 114, and the OR circuit 114 outputs the stop signal 1 to the first image forming device 12. Although the jam signal is also input into the AND circuit 118, an L signal, as the transport path selection signal output from the first image forming device 12, is also input into the AND circuit 118 because of the simplex mode. Since the AND circuit 118, therefore, does not output a signal, the stop signal 2 is not output. Since the first image forming device 12 stops simultaneously and thus the transport signal 1I becomes Low (OFF), the transport signal 1 is not output from the AND circuit 124.

L: Since the second image forming device 14 stops printing, and the transport signal 21 becomes Low (OFF), the transport signal 2 is not output from the AND circuit 126.

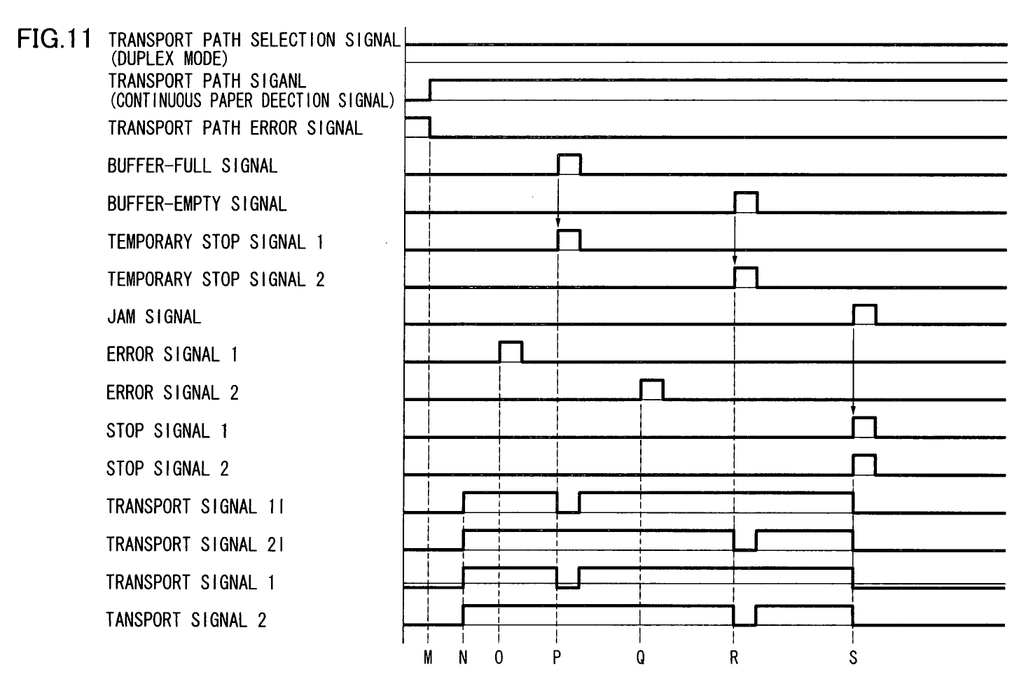

The duplex mode is explained below. FIG. 11 is a chart illustrating the operation in the duplex mode (see FIGS. 5 and 6), and the operation in the duplex mode is explained below with reference to FIG. 11.

M: The transport path signal is switches from the L signal (duplex mode) into the H signal (duplex mode), and the transport path error signal becomes Low (OFF), so that an image can be formed (as previously described).

N: The first image forming device 12 and the second image forming device 14 start printing simultaneously. The transport signals 1I and 21 are input into the AND circuits 124 and 126, respectively, and the signal which is obtained by causing the transport path selection signal output from the first image forming device 12 (High in the duplex mode) to pass through the inverter circuit 108, namely, the signal obtained when the H signal in the duplex mode becomes an L signal, is also input. For this reason, the transport signals 1 or 2 are not output.

O: The error signal 1 output from the first post-processing device 222 is input into the AND circuit 116, but a signal which is obtained by causing the transport path selection signal output from the first image forming device 12 (High in the duplex mode) to pass through the inverter circuit 108, namely, the signal obtained when the H signal in the duplex mode becomes an L signal, is also input into the AND circuit 116. For this reason, the AND circuit 116 does not output a signal. The OR circuit 114, therefore, does not output the stop signal 1 to the first image forming device 12.

P: Since a buffer-full signal is input, the temporary stop signal 1 is output so that the first image forming device 12 is temporarily stopped.

Q: The error signal 2 output from the second continuous paper feeding device 218 is input into the AND circuit 122, and a signal which is obtained by causing the transport path selection signal output from the image forming device 12 to pass through the inverter circuit 108, namely, the signal obtained when the H signal in the duplex mode becomes an L signal is also input into the AND circuit 122. For this reason, the AND circuit 122 does not output a signal. The OR circuit 120, therefore, does not output the stop signal 2 to the second image forming device 14.

R: Since a buffer-empty signal is input, the temporary stop signal 2 is output, so that the second image forming device 14 temporarily stops.

S: When the jam signal output from the buffer device 70 is input into the OR circuit 114, the OR circuit 114 outputs the stop signal 1, so that the first image forming device 12 stops. Further, the jam signal output from the buffer device 20 is input also to the AND circuit 118. Since the H signal as the transport path selection signal from the image forming device 12 is also input into the AND circuit 118, the AND circuit 118 outputs the signal to the OR circuit 120, and the OR circuit 120 outputs the stop signal 2 to the second image forming device 14.

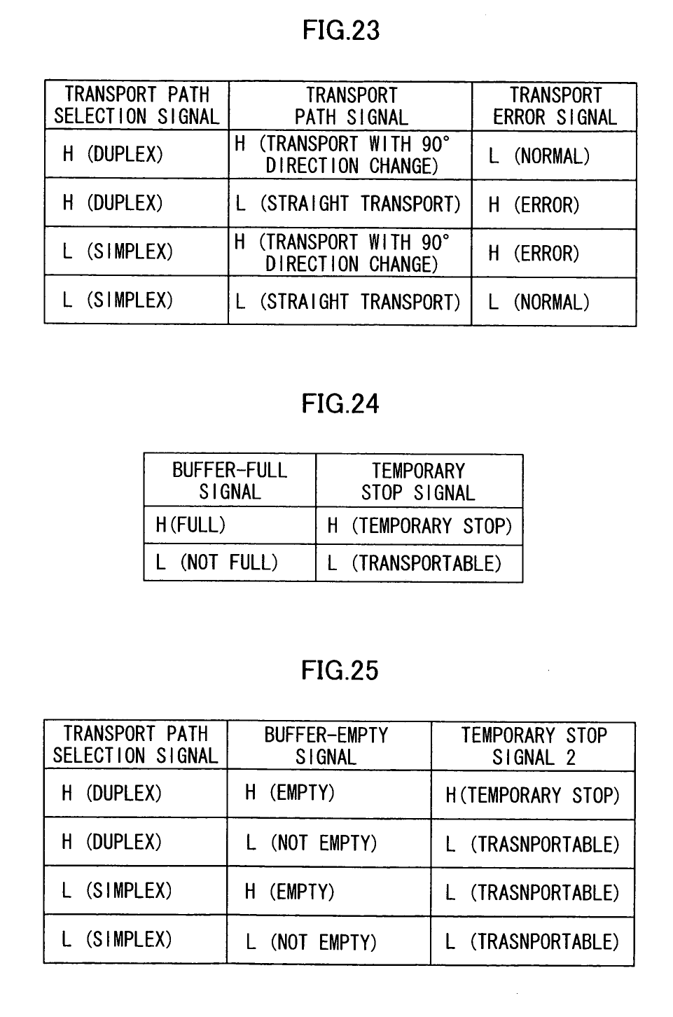

Relationships among the signals explained above are shown in FIGS. 23 to 27.

The table of FIG. 23 shows the relationship among the transport path selection signal as the printing mode signal, the transport path signal from the turn bar device 80 (the detection signal from the sensor 88 of the turn bar device 80 which is Low in the simplex mode and High in the duplex mode), and the transport path error signal.

The table of FIG. 24 shows the relationship between the buffer-full signal from the buffer device 70 and the temporary stop signal 1 for temporarily stopping the first image forming device 12.

The table of FIG. 25 shows the relationship among the transport path selection signal, the buffer-empty signal from the buffer device 70, and the temporary stop signal 2 for temporarily stopping the second image forming device 14.

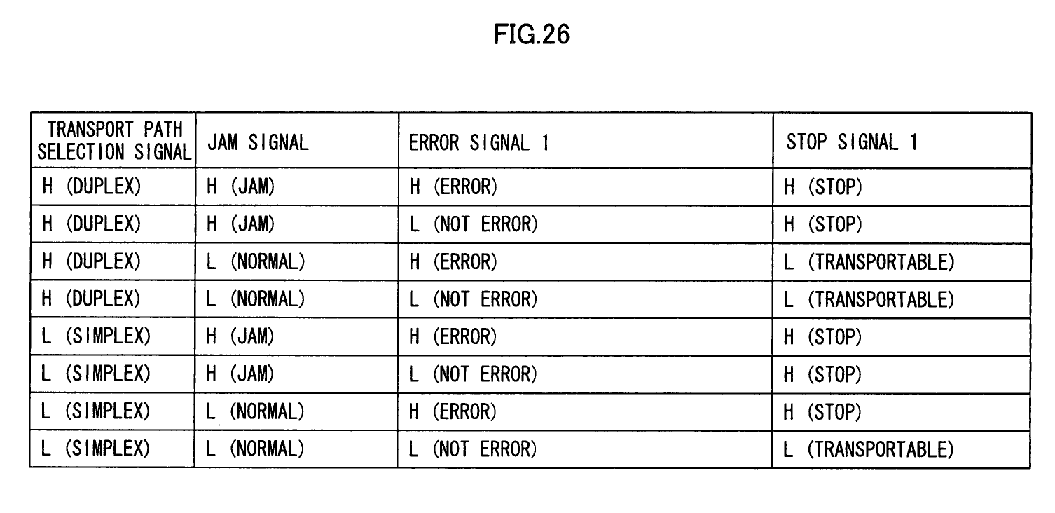

A table of FIG. 26 shows the relationship among the transport path selection signal, the jam signal from the buffer device 70, the error signal 1 from the first post-processing device 222, and the stop signal 1 for stopping the first image forming device 12.

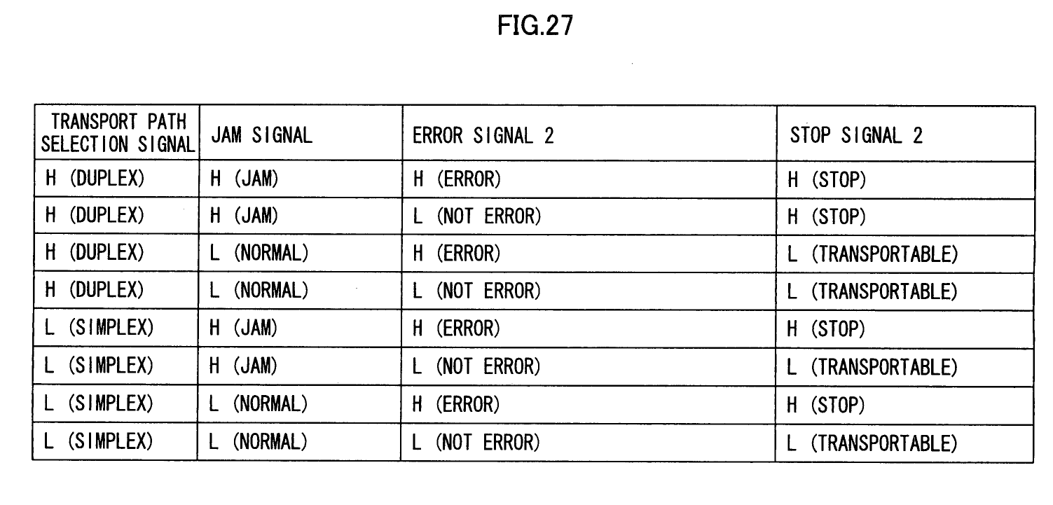

A table of FIG. 27 shows the relationship among the transport path selection signal as the printing mode signal, the jam signal from the buffer device 70, the error signal 2 from the second continuous paper feeding device 218, and the stop signal 2 for stopping the second image forming device 14.

The operation of this embodiment is explained below.

As explained above, both the duplex mode, for printing an image on both the front surface 28A and the rear surface 28B of the continuous paper 28 (see FIG. 5), and the simplex mode, for printing an image on only one surface (see FIG. 7), can be executed without changing the arrangements of the respective devices.

The control device 100 operates the first image forming device 12 only when the continuous paper 28 is mounted properly, and not when mounted improperly. For this reason, problems due to mis-mounting of the continuous paper 28 can be prevented.

The control device 100 aggregates interface signals output from the respective devices, and controls the operations of the first image forming device 12 and the second image forming device 14 based on the transport path signal from the first image forming device 12. When, therefore, the duplex mode and the simplex mode are switched, a worker does not have to reconnect cables and operate the respective devices. For this reason, improper connection and mis-operation are prevented.

In order to detect mounting of the continuous paper 28 to the turn bar device 80, the sensor 88 is provided to the turn bar 86, so as to detect whether or not the continuous paper 28 is wound around the turn bar 86 in this embodiment. Other methods may, however, be used.

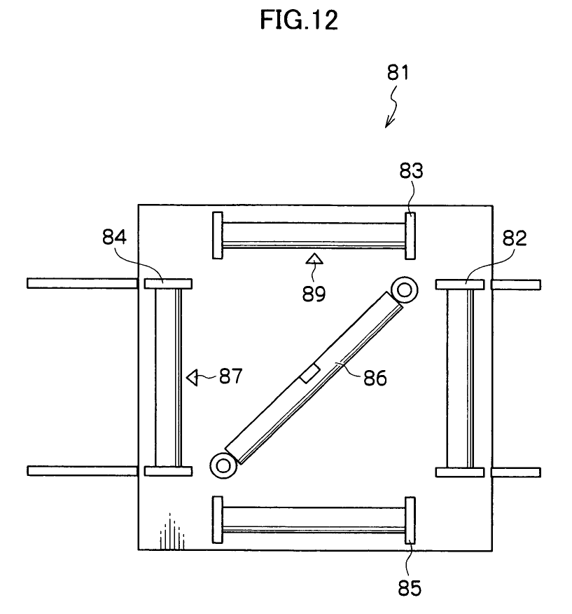

As shown in FIG. 12, for example, detection sensors 87 and 89 that detect the presence/absence of the continuous paper 28 are provided on or at the vicinities of the paper transport units 83 and 84. The detection sensors 87 and 89 may detect the paper transport direction in such a manner that when the detection sensors 87 and 89 detect the continuous paper 28, the simplex mode is selected and when the sensors do not detect the continuous paper 28, the duplex mode is selected. The detection sensors may be provided to the paper transport units 82 and 85 or in the vicinities thereof. Namely, detection may be made as to whether or not the continuous paper 28 is mounted along the first transport path K1.

The control method, diagrams and the like are omitted. However, only one of the first image forming device 12 and the second image forming device 14 is used in the simplex mode so as to perform the printing. In this case, when an image forming device which is not being used is not operating, the wear and tear (abrasion) of the photoreceptor 42 not being used (see FIG. 2), for example, is prevented.

A duplex continuous printing system 11 according to a second embodiment of the invention is explained below. Similar elements to the previous embodiment are designated by the same numbers, and explanation thereof is omitted.

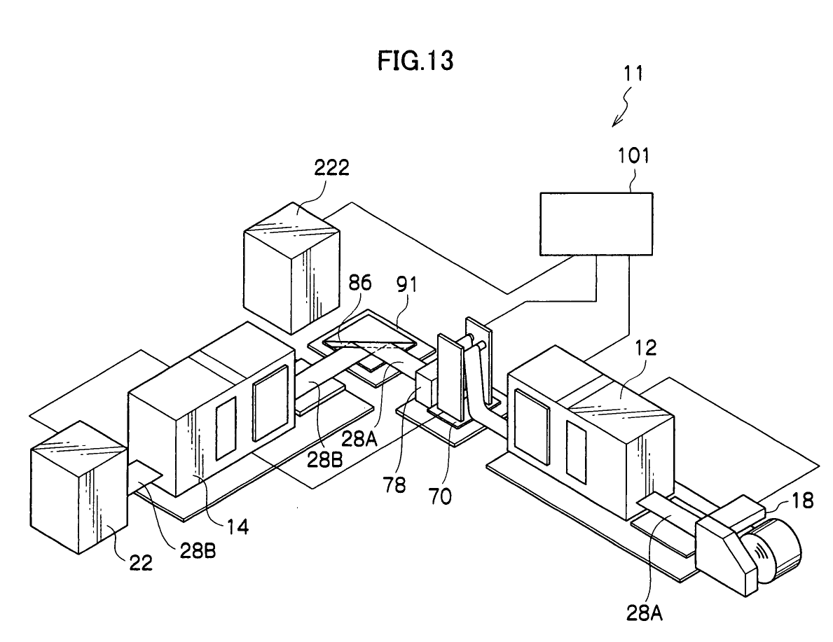

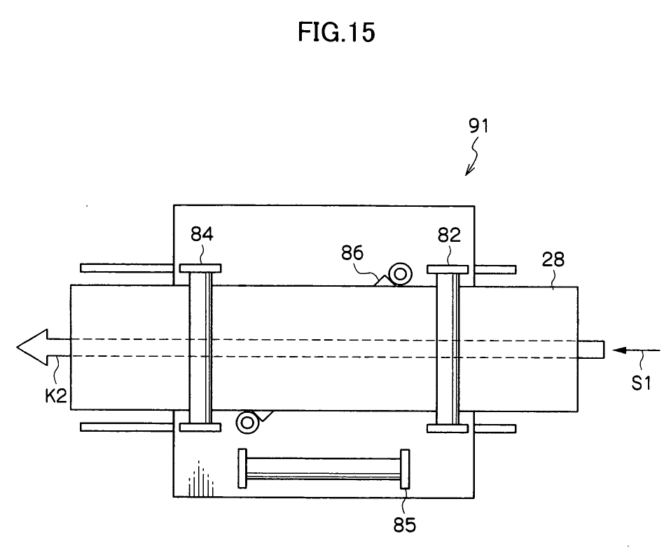

As shown in FIG. 13, the duplex continuous printing system 11 in the second embodiment has a constitution formed by eliminating the second continuous paper feeding device 218 (see FIG. 1) from the duplex continuous printing system 10 in the first embodiment, and the respective devices are arranged into a T-shape. As shown in FIG. 15, the turn bar device 91 does not have the paper transport unit 83. Therefore, the first transport path K1 (see FIG. 6) and the second transport path K2 are provided, but the third transport path K3 (see FIG. 8) is not provided.

Connection of the interface signals is explained below.

As shown in FIG. 13, the first continuous paper feeding device 18 and the first image forming device 12 are connected. The second post-processing device 22 and the second image forming device 14 are connected. The second image forming device 14 is connected also to the buffer device 70. The control device 101 is connected to the first image forming device 12, the second image forming device 14, the buffer device 70 and the first post-processing device 222.

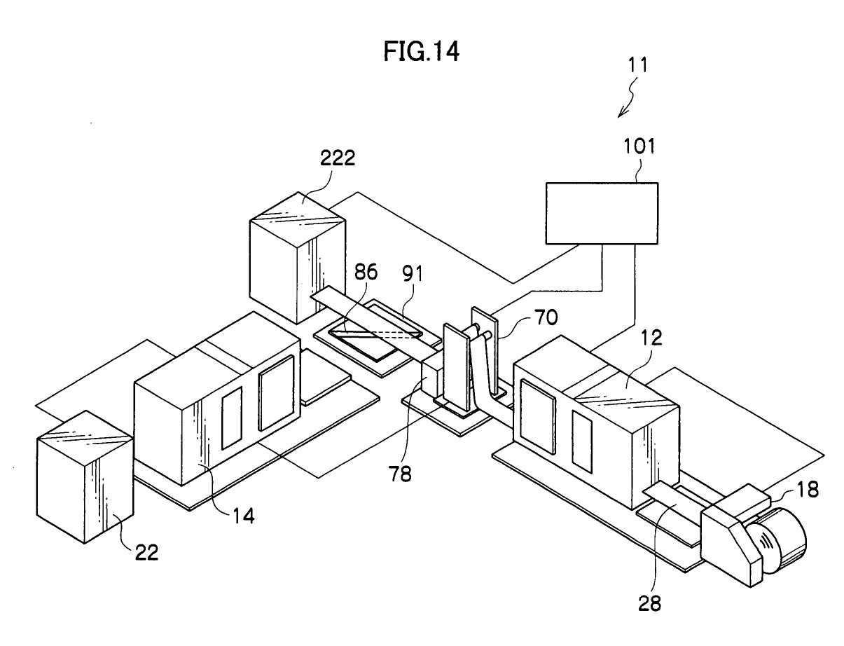

In the duplex continuous printing system 11 in the second embodiment, as shown in FIG. 13, the duplex mode is similar to that in the first embodiment. As shown in FIG. 14, however, in the simplex mode, only the first image forming device 12 prints an image, and the operation of the second image forming device 14 is stopped.

The control device 101 performs switching so as to operate both the buffer device 70 and the first post-processing device 222 in the simplex mode, and operate only the buffer device 70 in the duplex mode. In such a manner, the control device 101 controls the entire system so that appropriate operations are performed according to the printing modes.

The duplex continuous printing system 13 according to a third embodiment of the invention is explained below. Similar elements in this embodiment to the previous embodiments are designated by the same numbers, and explanation thereof is omitted.

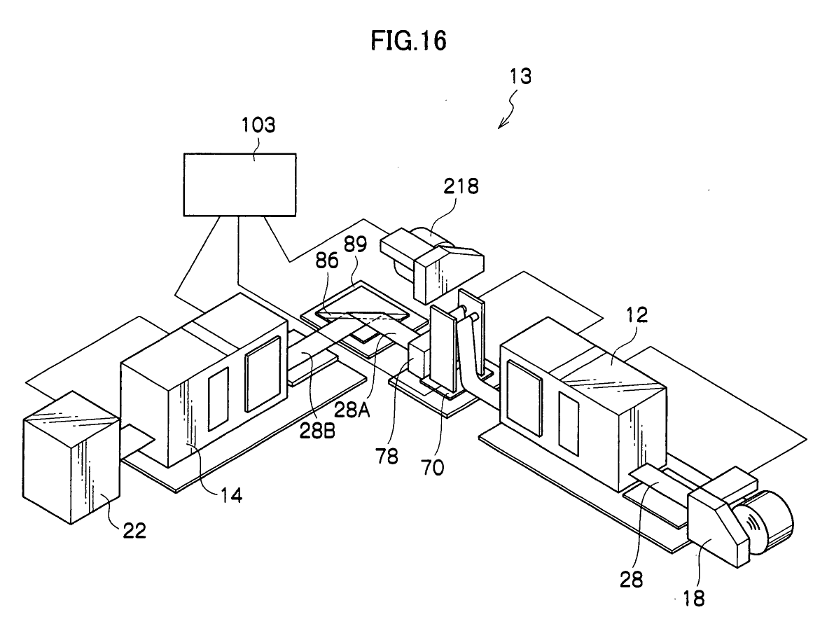

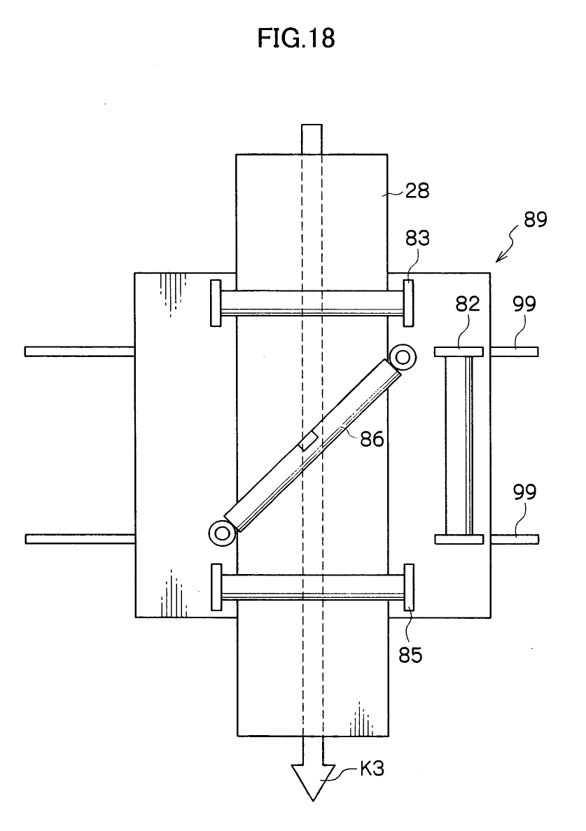

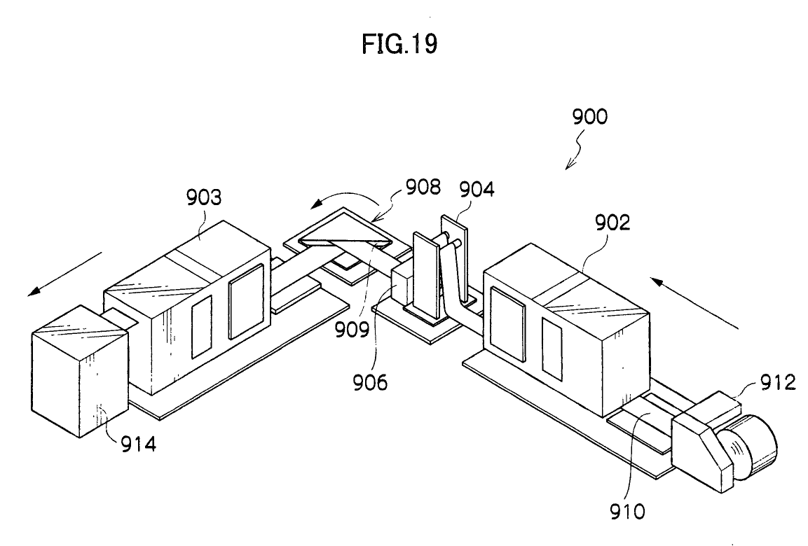

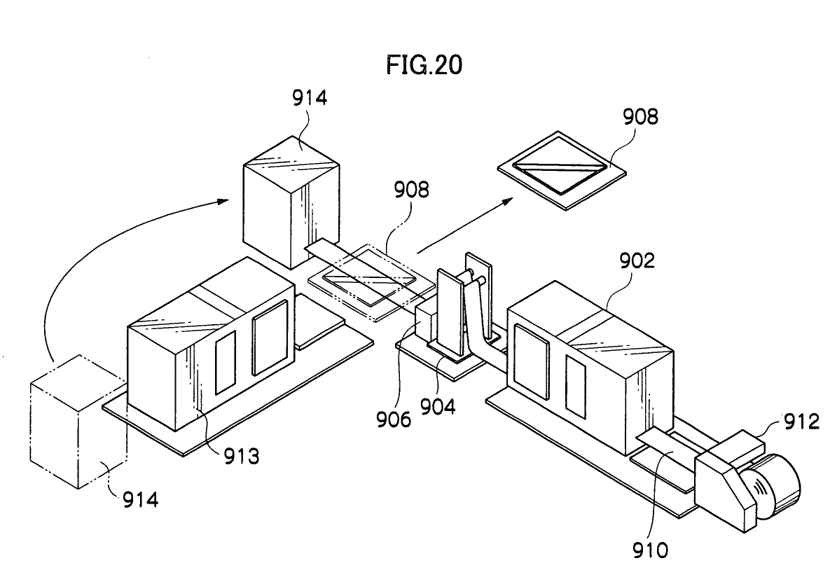

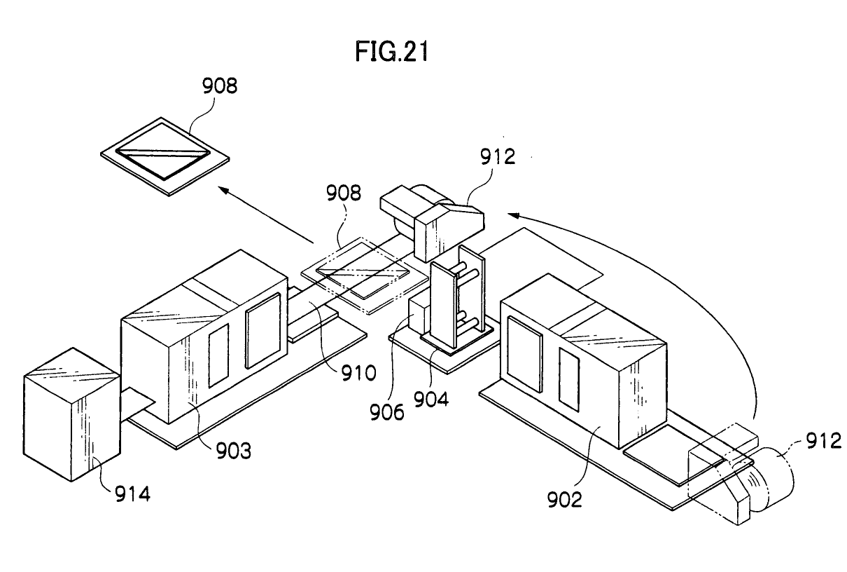

As shown in FIG. 16, the duplex continuous printing system 13 in the third embodiment has a constitution formed by eliminating the first post-processing device 222 (see FIG. 1) from the duplex continuous printing system 10 in the first embodiment, and the respective devices are arranged into a T-shape. As shown in FIG. 18, the turn bar device 89 does not have the paper transport unit 84. Therefore, the first transport path K1 (see FIG. 6) and the third transport path K3 are provided, but the second transport path K2 (see FIG. 8) is not provided.

Connection of the interface signals is explained below.

As shown in FIG. 16, the first continuous paper feeding device 18 and the first image forming device 12 are connected. The first image forming device 12 is connected also to the buffer device 70. The second post-processing device 22 and the second image forming device 14 are connected. The control device 103 is connected to the first image forming device 12, the second image forming device 14, the buffer device 70 and the second continuous paper feeding device 218.

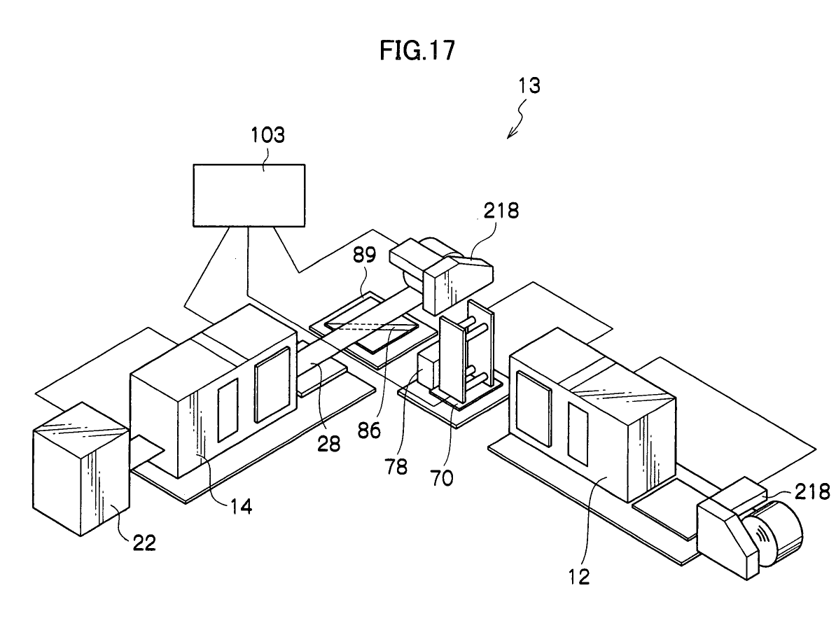

In the duplex continuous printing system 13 in the third embodiment, the duplex mode is similar to that in the first embodiment as shown in FIG. 16, but in the simplex mode, as shown in FIG. 17, only the second image forming device 14 prints an image, and the operation of the first image forming device 12 is stopped.

The control device 103 operates the second continuous paper feeding device 218 in the simplex mode, and stops the buffer device 70. In the duplex mode, on the contrary, the control device 103 performs switching so as to stop the second continuous paper feeding device 218 and operates the buffer device 70. The control device 103 controls the entire system so that appropriate operation is performed according to the printing modes.

The functions of the duplex continuous printing system 11 in the second embodiment and the duplex continuous printing system 13 in the third embodiment are similar to that in the first embodiment. In the simplex mode, however, in the case where both the first image forming device 12 and the second image forming device 14 are not required to simultaneously perform printing, the second and third embodiments are more preferable, because their constitutions are simple and inexpensive.

The invention is not limited to the above embodiments.

In the embodiments, for example, the signal for selecting the printing in the duplex mode or the printing in the simplex mode, namely, the transport path selection signal as the printing mode signal is output from the first image forming device 12, but this signal may be output from the second image forming device 14. Or both the first image forming device 12 and the second image forming device 14 could output signals, and the control device 100 may determine whether these signals match.

Also, the first image forming device 12 and the second image forming device 14 form images on the continuous paper 28 according to an electrophotographic method, but the invention is not limited to this. An image forming device may adopt an ink-jet method, a thermal transfer method, and another image forming methods.

Also, two image forming devices, the first image forming device 12 and the second image forming device 14 configured together, but three or more image forming devices may be configured together.

For example, the first post-processing device 222 and the second post-processing device 22 cut and stack the continuous paper 28, but the invention is not limited thereto. Such devices may process the continuous paper 28 on which an image is formed. For example, such devices may be devices that fold and store continuous paper without cutting, or winding devices that wind the continuous paper.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system including a plurality of image forming devices and having a simplex mode that an image is formed on a front surface of a continuous medium a duplex mode that an image is also formed on a rear surface of a continuous medium, the system comprising:
a first feed device that feeds a continuous medium;
a first image forming device that forms an image on the continuous medium fed from the first feeding device;
a turn bar device that is provided on a downstream side of the first image forming device; the turn bar device comprising
a first transport path that the continuous medium is transported in from the first image forming device, and transported out in a direction substantially perpendicular to the transporting-in direction of the continuous medium in a state in which the continuous medium is wrapped around a turn bar arranged at approximately 45° with respect to the advancing direction of the continuous medium to reverse the front and rear surfaces of the continuous medium, and
a second transport path that the continuous medium is transported out in a direction that is substantially the same as the transporting-in direction of the first transport path;
a first post-processing device that post-processes the continuous medium transported out by the second transport path of the turn bar device;
a second image forming device that forms an image on the continuous medium transported out by the first transport path of the turn bar device; and
a second post-processing device that is provided on a downstream side of the second image forming device and post-processes the continuous medium;
in the simplex mode, the continuous medium fed from the first feeding device being transported to the first post-processing device via the first image forming device and second transport path, and
in the duplex mode, the continuous medium being transported to the second post-processing device via the first image forming device, first transport path, and second image forming device.

2. An image forming system including a plurality of image forming devices and having a simplex mode that an image is formed on a front surface of a continuous medium, and a duplex mode that an image is also formed on a rear surface of a continuous medium, the system comprising:
a first feed device that feeds a first feed of continuous medium;
a first image forming device that forms an image on the continuous medium fed from the first feeding device;
a turn bar device that is provided on a downstream side of the first image forming device; the turn bar device comprising
a first transport path that the first feed of continuous medium, is transported in from the first image forming device, and transported out in a direction substantially perpendicular to the transporting-in direction of the first feed of continuous medium in a state that the first feed of continuous medium is wound around a turn bar arranged at approximately 45° with respect to the advancing direction of the first feed of continuous medium to reverse the front and rear surfaces of the first feed of continuous medium, and
a third transport path that transports in and out a second feed of continuous medium in a direction that is the same as the transporting-out direction of the first transport path;
a second feeding device that feeds the second feed of continuous medium to the third transport path of the turn bar device;
a second image forming device that forms an image on the first or second feed of continuous medium transported out from the turn bar device; and
a second post-processing device that is provided on a downstream side of the second image forming device and post-processes the first or second feed of continuous medium,
in the simplex mode, the continuous medium fed from the first feeding device being transported to the first post-processing device via the first image forming device and third transport path, and
in the duplex mode, the continuous medium being transported to the second post-processing device via the first image forming device, first transport path, and second image forming device.

3. An image forming system including a plurality of image forming devices and having a simplex mode that an image is formed on a front surface of a continuous medium, and a duplex mode that an image is also formed on a rear surface of a continuous medium, the system comprising:
a first feed device that feeds a first feed of continuous medium;
a first image forming device that forms an image on the first feed of continuous medium fed from the first feeding device;
a turn bar device that is provided on a downstream side of the first image forming device; the turn bar device comprising
a first transport path that the continuous medium is transported in from the first image forming device, and transported out in a direction substantially perpendicular to the transporting-in direction of the first feed of continuous medium in a state that the first feed of continuous medium is wound around a turn bar arranged at approximately 45° with respect to the advancing direction of the first feed of continuous medium to reverse the front and rear surface of the first feed of continuous medium,
a second transport path for transporting out a first feed of continuous medium in a direction that is substantially the same as the transporting-in direction of the first transport path, and
a third transport path that transports in and out a second feed of continuous medium in a direction that is substantially the same as the transporting-out direction of the first transport path;
a first post-processing device that post-processes the first feed of continuous medium transported out of the second transport path of the turn bar device;
a second image forming device that forms an image on the first or second feed of continuous medium transported out of the first transport path of the turn bar device; and
a second post-processing device that is provided on a downstream side of the second image forming device and post-processes the first or second feed of continuous medium;
in the simplex mode, the first feed of continuous medium fed from the first feeding device being transported to the first post-processing device via the first image forming device and second transport path, and in the duplex mode, the first feed of continuous medium being transported to the second post-processing device via the first image forming device, first transport path, and second image forming device.

4. The image forming system according to claim 3, wherein the second and third transport paths are disposed one above the other such that the first and second feeds of continuous medium can be transported respectively along the two transport paths at the same time.

5. The image forming system according to claim 1, further comprising:
a detection unit that detects whether or not the continuous medium is transported along the first transport path; and
a notification unit that gives notification of the detected result of the detection unit.

6. The image forming system according to claim 2, further comprising a detection unit that detects whether or not the first feed of continuous medium is mounted along the first transport path; and a notification unit that gives notification of the detected result of the detection unit.

7. The image forming system according to claim 3, further comprising:
a detection unit that detects whether the first feed of continuous medium is transported along the first transport path; and
a notification unit that gives notification of the detected result of the detection unit.

8. The image forming system according to claim 5, further comprising a determination unit that compares:
any one of printing mode signals, representing a duplex mode for forming an image on both surfaces of the continuous medium and a simplex mode for forming an image on one surface of the continuous medium, transmitted from one or both of the first image forming device and the second image forming device; with
a detected result of the detection unit, so as to determine whether the continuous medium is properly mounted.

9. The image forming system according to claim 6, further comprising a determination unit that compares:
any one of printing mode signals, representing a duplex mode for forming an image on both surfaces of the first feed continuous medium and a simplex mode for forming an image on one surface of the second feed of continuous medium, transmitted from one or both of the first image forming device and the second image forming device; with
a detected result of the detection unit, so as to determine whether the first or second feed of continuous medium is properly mounted.

10. The image forming system according to claim 7, further comprising a determination unit that compares:
any one of printing mode signals, representing a duplex mode for forming an image on both surfaces of the first feed of continuous medium and a simplex mode for forming an image on one surface of the second feed of continuous medium, transmitted from one or both of the first image forming device and the second image forming device; with
a detected result of the detection unit, so as to determine whether the first or second feed of continuous medium is properly mounted.

11. The image forming system according to claim 5, wherein the detection unit is provided at the turn bar device and detects whether the continuous medium is wrapped on the turn bar.

12. The image forming system according to claim 6, wherein the detection unit is provided at the turn bar device and detects whether the first feed of continuous medium is wrapped on the turn bar.

13. The image forming system according to claim 7, wherein the detection unit is provided at the turn bar device and detects whether the first feed of continuous medium is wrapped on the turn bar.

14. The image forming system according to claim 8, wherein the detection unit is provided on the turn bar device and detects whether the continuous medium is wrapped on the turn bar.

15. The image forming system according to claim 1, further comprising a control unit, that controls the image forming system based on a printing mode signal, representing a duplex mode for forming an image on both surfaces of the continuous medium or a simplex mode for forming an image on one surface of the continuous medium, wherein
the printing mode signal is a signal transmitted from one or both of the first and second image forming devices, and the printing mode signal causes the image forming system to operate in the duplex mode or simplex mode.

16. The image forming system according to claim 2, further comprising a control unit that controls the image forming system based on a printing mode signal, representing a duplex mode for forming an image on both surfaces of the first feed of continuous medium or a simplex mode for forming an image on one surface of the second feed of continuous medium, wherein
the printing mode signal is a signal transmitted from one or both of the first and second image forming devices, and the printing mode signal causes the image forming system to operate in the duplex mode or simplex mode.

17. The image forming system according to claim 3, further comprising a control unit that controls the image forming system based on a printing mode signal, representing a duplex mode for forming an image on both surfaces of the first feed of continuous medium or a simplex mode for forming an image on one surface of the second feed of continuous medium, wherein
the printing mode signal is a signal transmitted from one or both of the first and second image forming devices, and the printing mode signal causes the image forming system to operate in the duplex mode or simplex mode.

18. The image forming system according to claim 15, wherein the control unit aggregates interface signals output from the respective devices comprising the image forming system and controls operations of the first image forming device and the second image forming device based on the printing mode signal.

19. The image forming system according to claim 16, wherein the control unit aggregates interface signals output from the respective devices comprising the image forming system and controls operations of the first image forming device and the second image forming device based on the printing mode signal.

20. The image forming system according to claim 17, wherein the control unit aggregates interface signals output from the respective devices comprising the image forming system and controls operations of the first image forming device and the second image forming device based on the printing mode signal.
